(19) United States
(12) Patent Application Publication
(10) Pub. No.: US 2014/0272040 A1
(43) Pub. Date: Sep. 18, 2014

(54) Cheese Shred Product And Method Of Making

(71) Applicant: Kraft Foods Group Brands LLC, Northfield, IL (US)

(72) Inventors: Paul V. Gass, Glenview, IL (US); Brian E. LeVine, Evanston, IL (US); Melodie S. Bolin, Chicago, IL (US)

(21) Appl. No.: 14/210,949

(22) Filed: Mar. 14, 2014

Related U.S. Application Data
(60) Provisional application No. 61/798,748, filed on Mar. 15, 2013.

(51) Int. Cl. A23C 19/068; A23C 19/16

(52) U.S. Cl. CPC A23C 19/068; A23C 19/16
USPC 426/324; 426/512; 426/392; 426/582

(57) ABSTRACT

A method of forming cheese shreds having a wide or modified crescent shape is provided. By one approach, the method includes preparing a block of cheese by chilling the cheese to a predetermined temperature and/or reducing the size of the cheese block into cheese portions or cubes. Next, the cheese portions or cubes are fed into a shredder with shredding blades having a sinusoidal configuration. The shredder is operated to shred the cheese into modified crescent shapes with an upper and lower curved surfaces and tapered ends therebetween. Further, the modified crescent shaped cheese shreds have improved meltability such that a smaller amount of cheese can be used to achieve greater coverage, flavor, and mouth feel, as compared to previous cheese shred configurations.

### CROSS-REFERENCE TO RELATED APPLICATION

This application claims the benefit of U.S. Provisional Application Ser. No. 61/798,748, filed Mar. 15, 2013, which is hereby incorporated herein by reference in its entirety.

### TECHNICAL FIELD

This disclosure relates generally to cheese shreds and methods for producing cheese shreds, and more specifically, to methods of producing formed cheese shreds.

### BACKGROUND

Cheese is a popular food item that is consumed in many forms such as slices, chunks, crumbles, and shreds. Shredded cheese products are generally formed by cutting the desired shape of the cheese shred from a block or larger piece of cheese, or alternatively, extruding the cheese through a formed die to create cheese shreds. For certain types of cheese, cutting off the desired cheese shape from a larger block is advantageous and often less expensive that extruding the cheese shreds. Further, various approaches can be used to form such cheese shreds. For example, a wire cutter or mold can be used to form a cheese shred. More automated processes include the use of shredding dies, such as a reciprocating cutting die, a stationary die with a mechanism configured to force the cheese block into contact with the stationary die, or a rotating drum with a die.

Cheese shreds are consumed in many food items. For example, consumers often incorporate cheese shreds into pizza, nachos, mac and cheese, salads, scrambled eggs, quesadillas, lasagna, tacos, chili, and numerous other food items. Cheese shreds are often used for melting or cooking, and for these items, it is generally desirable to have a cheese that melts nicely. More particularly, consumers often desire a shredded cheese product that provides good, even coverage when melted, and one that is flavorful, does not clump or coagulate, and retains a desirable texture when heated, among other qualities.

Cheese shreds may take a wide variety of shapes and configurations. Many of the cheese shapes typically used in the art include a v-shaped shred, a flat shred, a square shred, a circular, or an oval shred, among others. Many of these cheese shred configurations are desirable for specific types of cheese or for particular uses. For example, harder cheeses often form flat shreds more easily than other shred configurations.

Due to a number of concerns such as those regarding health and obesity, consumers typically prefer to consume the minimal amount of food product necessary to achieve their desire satiety. For example, consumers prefer not to eat more than necessary to achieve a desired flavor, texture, mouth feel, and/or other desired food characteristic. In short, consumers are interested in minimizing unnecessary calories in the foods they consumer. Further, cheeses that can be easily prepared in food items and consumed by consumers are particularly popular with busy individuals.

### BRIEF DESCRIPTION OF THE DRAWINGS

FIG. 1 comprises a flow diagram of a cheese shred forming process as configured in accordance with various embodiments of the invention;

FIG. 2 comprises a cross section of a cheese shred as configured in accordance with various embodiments of the invention;

FIG. 3 comprises a cross section of a plurality of different cheese shreds;

FIGS. 4A-4B comprise a photograph and a schematic illustration of cheese shreds distributed over a given surface area;

FIGS. 5A-5B comprise a photograph and a schematic illustration of the cheese shreds of FIGS. 4A-4B after melting of the cheese shreds;

FIGS. 6A-6B comprise a photograph and a schematic illustration of cheese shreds distributed over a given surface area;

FIGS. 7A-7B comprise a photograph and a schematic illustration of the cheese shreds of FIGS. 6A-6B after melting of the cheese shreds;

FIGS. 8A-8B comprise a photograph and a schematic illustration of cheese shreds distributed over a given surface area;

FIGS. 9A-9B comprise a photograph and a schematic illustration of the cheese shreds of FIGS. 8A-8B after melting of the cheese shreds;

FIGS. 10A-10B comprise a photograph and a schematic illustration of cheese shreds distributed over a given surface area;

FIGS. 11A-11B comprise a photograph and a schematic illustration of the cheese shreds of FIGS. 10A-10B after melting of the cheese shreds;

FIG. 12 comprises a perspective view of a shredding blade configured in accordance with various embodiments of the invention;

FIG. 13 comprises a top view of the shredding blade of FIG. 12; and

FIG. 14 comprises a side view of the shredding blade of FIG. 12.

### DETAILED DESCRIPTION

Generally speaking, pursuant to these various embodiments, an exemplary cheese shred and process for forming such a cheese shred are illustrated. The shape of the cheese shred is specifically configured to have a modified crescent shape or, more generally, a wider and thinner configuration than conventional cheese shreds. The cheese shred also is configured to have a desired meltability, or melting properties, that provides improved melt coverage including the overall completeness of the coverage and the evenness of the coverage.

As described herein, a method for mass-producing formed cheese shreds may include providing a block of cheese to be shredded, chilling the cheese, reducing the block of cheese into portions or cubes, configuring the die openings of the shredder into oval shapes, feeding the cheese portions or cubes into the chamber or drum of a shredder, and operating the shredder to form the cheese portions or cubes into cheese shreds by forcing the cubes of cheese into engagement with the oval shaped openings of a shredding die that are formed with wavy or sinusoidal cutting blades. The formed cheese shreds generally have a modified crescent shape with a first curved side, a second curved side and two tapered or beveled ends joining the first and second curved sides. In one exemplary approach, the first or upper curved side and second or lower curved side of the formed cheese shred have a non-symmetrical degree of curvature between them. The modified crescent shape of the cheese shreds provides for improved coverage and meltability of the cheese over a given surface area. Further, such a cheese shred can be readily and efficiently incorporated into food items with minimal heat and time for cooking due to the relatively efficient melting of the cheese shred with the modified crescent shape. In addition, the method provides for applying an anti-cake agent to the formed cheese shreds having the modified crescent shape, and depositing the formed cheese shreds into a food package.

Turning now to FIG. 1, a method 50 for mass producing a shredded cheese product with improved meltability begins by providing 10 a block of cheese to be shredded. A variety of cheeses may be used with the process described here. Specifically, the types of cheese used with process 50 may include cheddar, mozzarella, Monterey jack, pepper jack, queso quesadilla, Colby, Swiss, and processed cheese, to note but a few options. Further, the cheese used with process 50 may have a variety of fat contents. As discussed further below, the cheese may have a moisture level between about 33% and about 59%, a fat on dry basis or a fat in dry matter of about 59% or less, and a salt concentration between about 0.2% to about 2.75%.

Full fat cheese shredded pursuant to process 50 generally has a fat dry basis of about 37% to about 60%, a moisture percentage of about 32% to about 52%, and a salt concentration of about 1.3% to about 2.3%. For example, a low-moisture, full fat mozzarella cheese shredded as described herein has a fat dry basis of about 39% to about 49%, a moisture level of about 45% to about 50%, and salt concentration of about 1.5% to about 2.1%. Further, if whole milk is used to make the low-moisture, full fat mozzarella, the fat dry basis will generally be in the range of about 45% to about 49%, whereas if a part skim milk is used for the low-moisture, full fat mozzarella, the fat dry basis will generally be in the range of about 39% to about 43%. By way of another example, a full fat cheddar cheese may have a fat dry basis of about 50% to about 58%, a moisture level of about 33.8% to about 38.8%, and a salt concentration of about 1.5% to about 2.1%. If a Monterey jack cheese shred is desired, the cheese may have a fat dry basis of about 50% to about 56%, a moisture level of about 39% to about 44%, and a salt concentration of about 1.5% to about 2%. Finally, a Colby cheese shredded as described herein may have a fat dry basis of about 50% to about 56%, a moisture level of about 36% to about 40%, and a salt concentration of about 1.5% to about 1.9%.

Cheese with a 2% milk fat that is shredded pursuant to the details provided herein generally have a fat dry basis of about 30% to about 44%, a moisture percentage of about 43% to about 53%, and a salt concentration of about 1.3% to about 2.4%. For example, a low-moisture mozzarella cheese with 2% milk fat that is shredded pursuant to the teachings herein have a fat dry basis of about 31.6% to about 35.2%, a moisture level of about 47.7% to about 51.3%, and salt concentration of about 1.5 to about 2%. By way of another example, a 2% milk fat cheddar cheese may have a fat dry basis of about 36.8% to about 42.6%, a moisture level of about 45.6% to about 47.9%, and a salt concentration of about 1.7% to about 2.3%. A 2% milk fat Monterey jack cheese shredded pursuant to process 50 may have a fat dry basis of about 36.2% to about 42.9%, a moisture level of about 44.5% to about 48.5%, and a salt concentration of about 1.6% to about 2%. A Colby cheese shredded as described herein may have a fat dry basis of about 32.7% to about 39.4%, a moisture level of about 45% to about 48%, and a salt concentration of about 1.6% to about 2.0%.

A low fat mozzarella cheese that is shredded pursuant to process 50 may have a fat dry basis of about zero to about 3.6%, a moisture level of about 55.2% to about 58.2%, and a salt concentration of about 2.1% to about 2.5%. Further, a fat free cheddar cheese shred may have a fat dry basis of about 0.8% to about 3.8%, a moisture level of about 55% to about 58%, and a salt concentration of about 2% to about 2.5%.

Also, the method 50 described herein may be used for forming a processed cheese shred. If processed cheese shreds are desired, the fat dry basis may be in the range of about 0 to about 60%, a moisture level in the range of about 30% to about 60%, and a salt concentration level in the range of about 0.5% to about 3.0%. By one approach, the fat dry basis may be in the range in the range of about 22.9% to about 28.3%, a moisture level in the range of about 52% to about 54%, and a salt concentration in the range of about 2% to about 2.4%.

In addition to providing the cheese, the process 50 may include chilling 12 the cheese. While cheese is often kept in a cooler or refrigerator, such a storage temperature is typically about 40° F., but process 50 includes further chilling 12 the cheese below that temperature. In one configuration, the cheese is chilled to a temperature of below 40° F., or even below about 35° F. In another configuration, the cheese is “super chilled” such that the cheese is disposed in a freezer at about 20° to 30° F. for between about three to five days such that the cheese reaches a temperature of between about 20° to about 30° F. By yet another configuration, the cheese is stored in a chilled environment at about 28° F. for about four days such that the cheese reaches a temperature of about 28° F. Further, some cheese, such as softer natural cheese or processed cheese products may require even colder temperatures during the shredding operation, and such cheeses may be cooled to a temperature of between about 10° F. to 20° F., and in one illustrative approach the cheese is cooled to a temperature of about 12° F. to 18° F. For certain softer cheese, the cheese may be chilled to a temperature of about 15° F.

The process 50 includes reducing 14 the blocks of cheese to a reduced sized portion or cube. The reduction 14 of the cheese blocks into smaller portions or cubes may occur before or after a chilling operation. In one embodiment, the cheese is chilled and then subsequently reduced in size and shredded. While the reduction in size ensures that the cheese blocks properly fits within a drum of a rotary die or chamber of a reciprocating or stationary shredder, it also assists with forming a cheese shred having a desired length and helps ensure the process 50 efficiently achieves a desired throughput.

By one approach, the larger cheese block is reduced into smaller, reduced-size portions or cubes through a series of wire harps. As described herein, the cheese block may be reduced into cheese portions or cubes having sides within the range of 1- to 4-inches. By one approach, the cheese portions or cubes have sides of about 1.5-inches to about 3.5-inches.

Prior to shredding the cheese, the shredder is configured to form openings that will produce the desired cheese shred configuration. The shredder itself may be a rotary shredder having a rotary drum with paddles or lugs that force the cheese into engagement with stationary shredding blades disposed on the circumference of the rotary drum. One illustrative shredding apparatus is the Urschel Model CC-D Shredder. The shredding blades typically form numerous openings through which the cheese shred passes through as they are separated from the remainder of the cheese portion or cube. Generally, the blades include a first blade set and a second blade set that form openings that create formed cheese shreds. The first and second blade sets may be mounted on plates that can be adjusted relative to one another to adjust the openings. For example, the blade sets can be adjusted laterally with respect to one another and can be adjusted radially, inwardly or outwardly, to change the depth of the opening. Generally, the openings between the first and second blade sets are configured to form a wide, flat cheese shred, as described herein.

In one example, the method 50 includes configuring 16 the first and second blade sets of the shredder into an offset arrangement to create oval shaped openings. By one approach, the first and second blade sets have a wavy, curved, or sinusoidal profile or configuration, as illustrated in FIGS. 12-14. The shredding apparatus may employ numerous shredding blades arranged one after the other, and it is anticipated that these blades may be arranged offset from one another. Together, the first and second blade sets with the sinusoidal configuration may be configured to create a plurality of generally oval-shaped openings. The shaped openings described herein are oval-shaped when viewed from inside the apparatus, but the cheese shred does not adopt the same shape as the entire opening. Further, the cheese does not completely fill this opening during the shredding process, as it might in an extrusion process, but instead different portions of the blades cut different sides or ends of the cheese shred, as described below.

In one configuration, multiple blades are mounted onto a plate, and a series of openings are defined by a first blade mounted on a first plate and a second blade mounted on a second plate. By one approach, the first and second plates are offset to a position of −0.001 to −0.06 of an inch to create the oval-shaped openings through which the cheese is advanced to form the modified crescent shaped cheese shreds. In another approach, the first and second plates are offset to a position of about −0.03 to about −0.05 of an inch. In one specific application, the plates are offset to a position of about −0.03 to −0.04. These positions are measured at the openings between the blades, where the cheese engages with the blade. Specifically, the positions are measured from a peak of the sinusoidal configuration of the blade to the adjacent base wall.

In one approach, the shredding blade 800, illustrated in FIGS. 12-14, may be used with method 50 to create cheese shreds having a modified crescent shape. As shown, the shredding blade 800 may have a sinusoidal configuration over which the cheese will pass. The shredding blade 800 will form the various distinct surfaces of the modified crescent cheese shred, as detailed below.

When the shredder is operated, the rotary drum will spin or rotate and force the cheese portions or cubes into engagement with the stationary blades that are configured in an offset arrangement. When the cheese portions or cubes contact the blades, a shred of cheese having a modified crescent shape is removed from the block or cube of cheese. The cut that separates the modified crescent cheese shred from the portion or cube of cheese also forms the upper curved side of the cheese as described below.

By operating the shredder as described herein, the blade sets that are configured into oval-shaped openings will form cheese shreds having a modified crescent shape. For example, as the cheese portion or cube is pushed into engagement with the sinusoidal shredding blade 800, a first cut is formed into the cheese portion or cube, and the first cut may form a lower cut or curved side 104 of the cheese shred having the modified crescent shape 100. Further, another set of cuts, which are formed with the next, offset shredding blade in the shredder, will form the ends 106 of the cheese shred 100, and a subsequent cut formed into the cheese portion or cube forms a top curved portion 102 of the cheese shred 100, thereby separating the cheese shred 100 from the remainder of the cheese portion. It is anticipated that the sinusoidal shredding blade 800 may form all of the discrete surfaces of the cheese shred 100. The surfaces 102, 104, 106, however, do not have the same geometry due to the portion of the shredding blade 800 that cuts the surface and the side of the blade 800 being used to form the surface. For example, the crest and/or trough of the sinusoidal shredding blade 800 may form the curved surfaces 102, 104, whereas the straighter portion of the shredding blade 800 between the crest and trough are used to form the tapered ends 106 of the cheese shred 100. The curved surfaces 102, 104 may have different radius of curvatures, as described further below, due to the side or surface of the shredding blade 800 forming the cut curved surfaces 102, 104.

Once the first and second plate sets of the shredder are configured 14 into the offset position described above, the cheese portions or cubes are fed 18 into the drum or chamber of the shredder. More specifically, the cheese portions or cubes are fed into the shredding drum from a conveyer above the shredding drum at a consistent rate such that the cheese within the shredding drum is maintained in contact with the blades but also avoids over feeding or clogging the machine. Then, the method 50 includes forming 20 the cheese portions or cubes into the modified crescent cheese shreds by operating the shredder or rotating the rotary drum. As the rotary drum is rotated, the cheese portions or cubes are forced into engagement with the stationary blades by the impellers, paddles, or lugs of the rotary drum. In one embodiment, the shredder includes a ten horsepower motor capable of operating at between about 425 to about 475 rpm.

During operation, the process 50 described herein may produce between about 1,000 to about 5,000 pounds of cheese shreds per hour, though this is often dependent or limited by the capability of the cheese packaging machines. Further, if the cheese will be sold in larger commercial quantities, the process 50 may produce up to 10,000 pounds of cheese shred per hour. By one illustrative approach, the process 50 produces about 3,000 pounds of cheese shreds per hour (or about 50 lbs./min.). This is typically achieved with a single unit or shredding drum, and also may include depositing and packaging steps described below.

As suggested above, the cheese shreds formed 20 according to process 50 have a wide configuration including a cross section with a modified crescent shape that typically has four distinct surface areas, two of which are sides that curve in the same direction. More particularly, the cheese shred 100 includes a top curved side 102 with a major curvature, a lower curved side 104 with a minor curvature, and two tapered ends 106 joining the top and lower curved sides 102, 104.

Though the cross section of cheese shred 100 has a modified crescent shape, the particular dimensions of the cheese shred may have some variability. For example, it is anticipated that the cheese shred 100 has a width in the range of about 7 mm to about 12 mm. Further, the height or thickness of the cheese shred 100 may be about 0.7 mm to about 3.6 mm. Though the cheese shred 100 may have a variety of dimensions, it is anticipated that the cheese shred 100 may have an aspect ratio (or a ratio of the thickness or height of the cheese shred over the width) in the range of between about 0.1 to about 0.3. Thus, as illustrated in FIG. 3, the modified crescent cheese shred 100a may have a thickness or height, hₐ, that is greater than the height, h_{b}, of the cheese shred 100b, and the cheese shred 100b may have a width, w_{b}, that is similar to the width, wₐ, of cheese shred 100a, though both shreds 100a, 100b may still fall within the aspect ratio described herein. In sum, despite the specific dimensions of the cheese shred, it is anticipated that the shred will have an aspect ratio in the range of about 0.1 to about 0.3. Also, though the modified crescent shape is detailed herein, cheese shreds having other cross sectional shapes may have an aspect ratio of 0.1 to 0.3 to provide the cheese shreds with an improved meltability.

As noted above, the surfaces of cheese shreds 100 are configured to have a non-symmetrical degree of curvature between the first and second sides. In one illustrative example, the major curvature of the top curved side 102 is different from the minor curvature of the lowered curved side 104. To this end, such a combination of non-symmetrical major and minor curvatures permits the cheese shred 100 to have a recognizable modified crescent shape and provides the cheese shreds with improved meltability.

More particularly, the top curved side 102 has a larger radius of curvature than the lower curved side 104. In one illustrative configuration, a first radius of curvature of the top curved side 102 is between about 5.5 to about 6.8 and a second curved side of the lower curved side 104 is between about 4 to about 5. For example, the cheese shred 100 depicted in FIG. 2 has a first radius of curvature of 6.7 and a second radius of curvature of 4.2. As mentioned above, though the sinusoidal shredding blade 800 forms the top curved surface 102 and the lower curved surface 104, the cut surfaces of the cheese have different configurations due to the operation of the shredder and the portion or side of the blade that forms the cut.

The cheese shred 100 with the modified crescent shape has an increased surface area as compared to previous cheese shreds, such as a v-shred. By one approach, a cheese shred with a modified crescent cross section and a length of 10 mm will have a surface area between about 130 mm² to about 200 mm². In another illustrative example, a cheese shred with a modified crescent cross section and a length of 10 mm will have a surface area in the range of about 150 mm² to about 185 mm². By yet another approach, a modified crescent cheese shred with a length of 10 mm will have a surface area in the range of about 160 mm² to about 180 mm². In addition, the average length of the modified crescent cheese shred 100 is typically in the range of about 10 mm to 76.2 mm (0.39- to about 3.0-inches). By one approach, the cheese shreds are in the range of about 10 mm to 65 mm (0.39- to about 2.6-inch).

By forming 20 the cheese shreds with a modified crescent shape, the shredded cheese will have improved meltability when heated. For example, while a variety of cheese shred configurations may be available, the modified crescent shape disclosed herein has several advantages with respect to meltability and coverage, as discussed below.

Subsequent to forming the individual cheese shreds, the process 50 further includes applying 22 an anti-cake agent to the formed cheese shreds with the modified crescent shape to prevent the individual shreds from sticking or clumping together. In applying the anti-cake agent, a tumble drum may be employed downstream of the shredding equipment. In one approach, a tumble drum that includes baffles is used to mix or fold the cheese shreds 100 having the modified crescent shape with the anti-cake mix. In other configurations, the anti-cake agent may be an ingredient within the cheese.

A number of different anti-cake or flow agents can be applied to the cheese shreds, including, for example, starches, cellulose, and calcium sulfate, among others. Further, these may be used alone or in combination with one another. If food starches are incorporated into the anti-cake agent, the starches may include corn starch and potato starch, to note but a few options. One exemplary anti-cake agent may be found in a co-pending and co-owned application filed on Mar. 15, 2013 having application Ser. No. 13/840,020, and titled Cheese Anti-Cake for Enhanced Melt, which is incorporated by reference herein in its entirety.

As mentioned, the anti-cake is effective to hinder, and, in some cases, prevent sticking and agglomeration of the cheese shreds 100 during normal handling. The anti-cake agent, such as the lightly modified starch described in application Ser. No. 13/840,020, also may provide process stability during melting of the cheese, but yet disappear in the final melted product from an organoleptic and functional standpoint.

Specifically, the anti-cake may include a lightly modified starch that has gelatinization and viscosity profiles relative to the protein aggregation temperatures of the cheese shred 100 that allow for starch gelatinization to interrupt protein aggregation of the dairy protein in the cheese during melting and to contribute viscosity to the cheese melt, which lends stability to a cheese melting process. Thus, in addition to preventing the cheese shreds 100 from sticking together, the anti-cake agent also may enhance or improve the melting of the cheese shreds 100. In this manner, the cheese shreds 100 may melt smoothly and homogenously.

Further, the lightly modified starch, when used as the anti-cake agent, may decrease in their functional contribution to the melted cheese by rupturing and degrading, such that the lightly modified starch disappears in the final melted or heated cheese product, resulting in no textural, flavor, or other organoleptic contribution to the final melted product, such as any adverse organoleptic characteristics or negatively impacting flavor release

In one example, the lightly modified starch applied as the anti-cake agent to the cheese shreds 100 includes intact starch granules including amylopectin and substantially no amylose such that when the cheese shreds 100 undergo a uniform melting process, the starch granules swell and gelatinize to contribute viscosity to the cheese melt. Upon providing in-process stability to the cheese melt, the starch beings to rupture and dissipate through the melted cheese such that there is a uniform distribution of the amylopectin in the final cheese product, with substantially no intact starch granule, and substantially no starch agglomerates of the amylopectin in the melted cheese. In one configuration, the lightly modified starch granules on the outer surface of the cheese shreds 100 are about 0.1 to about 120 microns in size.

Once an anti-cake agent has been applied 22 to the modified crescent cheese shred, the process 50 also includes depositing 24 the formed cheese shreds 100 into a food package for delivery to consumers. The package used for distribution may depend on the amount of cheese shreds being distributed. For example, the food package or container may include a flexible film pouch, a semi-rigid container, or a rigid container, among others.

As mentioned above, the cheese shreds 100 with the modified crescent shape have improved meltability and coverage such that less cheese product may be necessary to achieve a desired coverage, mouth feel, texture, and/or taste.

To illustrate the desired meltability and coverage of the cheese shreds with the modified crescent shape, FIGS. 4A-5B illustrate 40 grams of cheddar cheese shreds 100 having the modified crescent shape distributed over an 8-inch round tortilla 400. In one approach, the tortilla is a flour tortilla from Casa De Oro Foods that is placed directly onto a griddle when heated. As illustrated in FIG. 4A, when the cheese shreds 100 are deposited on the surface of the tortilla 400 (prior to melting), the shreds cover about 72% of the surface of the tortilla 400. FIG. 4B is a black and white depiction of the distribution of the cheese, and FIG. 4A is a more detailed picture illustrating the cheese. FIGS. 5A-5B illustrate the tortilla 400 after a heating or melting operation. In the example of FIGS. 5A-5B, the tortilla 400 was heated on the griddle set at 350° F. for a length of four minutes. After the heating operation, the cheese shreds 100 have melted to produce 89% coverage of the tortilla 400.

From the detailed shading in the picture of FIG. 5A, it is apparent that the melted cheese has a generally even melt profile such that there are no clumping or overly concentrated areas. Further, the cheese shreds 100 have sufficiently melted in FIG. 5A such that individual cheese shreds 100 have very little, if any, individual shred identity such that the cheese has become a cheese mass with a good, confluent melt and the melted cheese is generally evenly melted over the surface of the tortilla 400. While the improved cheese melt and coverage is a function of the even distribution of the cheese shreds, it also is due, in part, to the composition of the cheese, the cross sectional configuration of the cheese shreds having an optimal surface area, and the anti-cake agent that helps the cheese shreds 100 to retain their distinct nature so that the cheese shreds 100 can be easily spread over the surface of the tortilla 400. Further, if a lightly modified starch is employed, such as that described above, the starch may provide process stability during the melting process and functionally disappear in the final melted product such that the cheese shreds may have a more smooth and homogenous melt. In light of these factors, an improved meltability is achieved in a shorter period of time and at a lower temperature. In addition, the improved meltability results in consumers being required to use less of the cheese shreds to obtain a desired texture, mouth feel, and/or taste. In one aspect, the cheese shreds 100 that are melted on the tortilla 400 do not require the same amount of heat and length of time as other shred configurations to provide a desired coverage and melt texture in a static melting environment. Further, the cheese shreds 100 with the modified crescent shape also display improved meltability when the cheese is heated in the presence of a shear force, such as when being stirred in a pot, or other dynamic melting situations. In such configurations, the cheese shreds 100 displays minimal shred identity such that the cheese melts together into a confluent cheese mass in less time and under less heat.

FIGS. 6A-7B illustrate the distribution and melting characteristics of 40 grams of the cheese shred 150, which has a v-shaped cross section, as shown in FIG. 3. The v-shaped cheese shred 150 typically has an aspect ratio of 1, such that the cheese shred has the same thickness or height as it does width. Due to the cross sectional configuration of the cheese shred 150, the relatively even distribution of the 40 grams of cheese shreds 150 over the surface of an 8-inch tortilla 600 yields only 56% coverage of the surface of the tortilla. Once the tortilla 600 has been heated on a griddle at a temperature of about 350° F. for four minutes, the cheese shreds 150 cover 76% of the surface of the 8-inch tortilla. In addition, as can be seen from the photograph in FIG. 6A, the melted cheese does not have the same even distribution as that shown in FIG. 5A, but instead, has shallow zones where the melted cheese covers the tortilla 600 very thinly and other areas where there is no cheese coverage. Further, the cheese distribution has not melted into a confluent mass, but instead, the individual shreds 150 retain their individual identity, even after the tortilla 600 is heated. Thus, the melt coverage of the v-shaped cheese shred 150 is not as complete or desirable as the melt coverage obtained with the modified crescent shape cheese shred 100. Further, when cooking with the v-shaped cheese shred 150, this shred typically require more heat and longer heating times to obtain the same confluent cheese mass from the individual cheese shreds 150.

By way of another example in FIG. 10A, another 40 grams of the v-shaped cheese shred 150 were distributed over another 8-inch round tortilla 1000. The 40 grams of cheese shred 150 are identical to the shreds on the tortilla 600, though the cheese shreds 150 shown in FIG. 10A appear to be in a more orderly arrangement. As shown in FIG. 10A, the unmelted cheese shreds 150 cover 55% of the surface of the tortilla 1000. Further, once the tortilla has been heated on a griddle at a temperature of about 350° F. for four minutes, the cheese shreds 150 cover 69% of the surface of the 8-inch tortilla 1000, as depicted in FIG. 10B. As discussed above, the melted cheese shreds 150 do not have the same even distribution as the melted cheese shreds 100 shown in FIG. 5A and cheese shreds 150 retain a high degree of shred identity.

FIGS. 8A-9B illustrate the distribution of 40 grams of cheese shreds 130 over an 8-inch tortilla 700. The cheese shreds 130 have a generally oval-shaped cross section with pinched ends, as shown in FIG. 3. Due to the cross sectional configuration of the cheese shred 130, the relatively even distribution of the 40 grams of cheese yields only 54% coverage of the surface area of the tortilla. Further, once tortilla 700 is heated on a griddle at 350° F. for four minutes, the cheese shreds have melted to provide a 75% surface coverage of the surface of the tortilla. Further, as can be seen from FIG. 9A, the melted cheese distribution of cheese shreds 130 does not have an even, smooth coverage, but instead the melted cheese has very significant independent shred identity. Thus, the cheese shreds 130 have not melted into a confluent, even cheese mass. Further, the melt coverage of the oval-shaped shred 130 is not as complete as the melt coverage obtained with the modified crescent shaped cheese shred 100. Further, cooking with the oval-shaped cheese shred 130 typically requires more heat and longer heating times to obtain the same confluent melted mass from the individual shreds as compared to that obtained with the modified crescent shaped cheese shreds 100.

Though the modified crescent shape of the cheese shred 100 helps achieve good meltability, a cheese composition, such as those described above, also helps ensure the good melt that results in a confluent and smooth mass of melted cheese from the individual cheese shreds, thereby avoiding apparent fat collections or pooling free oil. Further, depending on the desired anti-cake agent that is used, it may assist with absorbing the oil to further ensure that good meltability is obtained without visible oil separation.

To further improve meltability, the cheese shreds 100 or those with a wide aspect ratio may be treated with a dairy powder such as a cream cheese powder. One exemplary powder may be found in co-pending and co-owned application filed on Apr. 1, 2011 having application Ser. No. 13/078,673, titled Cheese with Improved Organoleptic and Melting Properties, which is incorporated by reference herein in its entirety. The cheese shreds 100 also may be treated with the melt-enhancing anti-cake agent described above.

A shredded cheese product with an improved meltability, as described herein, is a function of a number of variables. More particularly, the meltability index may depend upon the cheese properties, such as the type and composition of cheese, the shape of the cheese including the cross section and length of the cheese shreds, the surface area of the cheese shreds, the initial coverage or distribution of the shreds, the heat used to melt the cheese, and the length of time of the heat application. Further, the meltability of a cheese shred may be improved with a treatment, such as by coating the cheese shred with a dairy powder or a melt-enhancing anti-cake agent, to thereby improve the meltability factor of the cheese shred. Thus, as described herein, a cheese shred with a high meltability factor on the meltability index typically has a larger surface area, has a higher moisture level, higher fat content, and/or lower protein level, and only needs to be exposed to a heat treatment for a shorter period of time to achieve the desire melt characteristics such that the individual shreds have melted into a confluent, even mass of cheese from the individual cheese shreds such that the individual shreds are no longer easily detectable from the melted mass of cheese shreds.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed:

1. A method for mass-producing a shredded cheese product having improved meltability, the method comprising:
providing a block of cheese to be shredded;
feeding the block of cheese to a rotary shredder having a rotary drum;
forming a formed cheese shred with the rotary shredder, the formed cheese shred having a modified crescent shape with a first curved side, a second curved side and two tapered ends joining the first and second curved side, the formed cheese shred having a non-symmetrical degree of curvature between the first and second curved sides; and
wherein the first curved side has larger radius of curvature than the second curved side and the modified crescent cheese shred exhibiting a high meltability factor such that individual ones of the formed cheese shreds with the modified crescent shape are not distinguishable from a mass of the melted modified crescent shape cheese shreds.

2. The method of claim 1 wherein the first curved side has a first radius of curvature between about 5.5 to about 6.5 and the second curved side has a second radius of curvature of between about 4 to about 5.

3. The method of claim 1 further comprising applying an anti-cake agent to the formed cheese shred.

4. The method of claim 1 wherein the modified crescent shape of the formed cheese shred has a width of between about 7 to 12 mm.

5. The method of claim 1 wherein the modified crescent shape of the formed cheese shred has an aspect ratio of between about 0.1 to about 0.3.

6. The method of claim 1 wherein the modified crescent shape of the formed cheese shred has a surface area of between about 130 mm² to 200 mm² for a 10 mm long portion of the formed cheese shred.

7. The method of claim 1 wherein the modified crescent shape of the formed cheese shred has a surface area of between about 150 mm² to 185 mm² for a 10 mm long portion of the formed cheese shred.

8. The method of claim 1 wherein the modified crescent shape of the formed cheese shred has a surface area of between about 160 mm² to 180 mm² for a 10 mm long portion of the formed cheese shred.

9. The method of claim 1 further comprising depositing the formed cheese shreds into a food package.

10. A method of mass producing a packaged cheese product comprising:
shredding blocks of cheese into formed cheese shreds wherein the formed cheese shreds have a modified crescent shape having two curved surfaces and tapered ends formed therebetween, the formed cheese shreds have an aspect ratio of between about 0.1 to about 0.3;
applying an anti-caking agent to the formed cheese shreds;
collecting a plurality of the formed cheese shreds and filling a container with the formed cheese shreds; and
sealing the container having the formed cheese shreds therein.

11. A shredded cheese product with improved meltability, the shredded process cheese product comprising:
a cheese shred having a modified crescent shape with an upper curved side and a lower curved side that both curve in the same direction, the upper curved side being longer than the lower curved side; and
wherein the upper curved side has a first radius of curvature of between about 5.5 to about 6.5 and the lower curved side has a second radius of curvature of between about 4 to about 5.

12. A method for mass-producing a shredded cheese product having improved meltability, the method comprising:
providing a block of cheese to be shredded;
feeding the block of cheese to a rotary shredder having a rotary drum;
forming formed cheese shreds with the rotary shredder, the formed cheese shreds having a wide shape with an aspect ratio of between about 0.1 to about 0.3; and
wherein the formed cheese shreds with the wide shape have improved meltability such that upon exposure to a heat source, the formed cheese shreds exhibit a confluent melt and the individual formed cheese shreds are not distinguishable from a mass of the melted formed cheese shreds.
